(19) United States
(12) Patent Application Publication
(10) Pub. No.: US 2024/0349014 A1
(43) Pub. Date: Oct. 17, 2024

(54) PROXIMITY SYSTEM FOR DETERMINING THE CO-LOCATION OF ELECTRONIC DEVICES

(71) Applicant: Co-Moving Carpool Ltd., Tel Aviv (IL)

(72) Inventors: Tamir SCHERZER, Herzliya (IL); Idan HAIL, Ya'ad (IL); Erez RAHAMIM, Tel Aviv (IL)

(21) Appl. No.: 18/683,776

(22) PCT Filed: Aug. 23, 2022
(86) PCT No.: PCT/IB2022/057881

§ 371 Date: Feb. 15, 2024

Related U.S. Application Data
(60) Provisional application No. 63/235,817, filed on Aug. 23, 2021.
(60) Provisional application No. 63/327,842, filed on Apr. 6, 2022.

(51) Int. Cl. H04W 4/02

(52) U.S. Cl. CPC H04W 4/023

(57) ABSTRACT

Determining the co-location of a group of electronic devices by receiving a communication providing the current location of a primary electronic device of the group, responsive to, and within a predefined amount of time after, receiving the communication, instructing at least one secondary electronic device of the group to provide their current location, receiving a communication providing the current location of the at least one secondary electronic device, and determining that the electronic devices meet a predefined co-location condition by determining that the current location of the primary electronic device is within a predefined minimum distance from the current location of the at least one secondary electronic device, and determining that the communications from the primary electronic device and the at least one secondary electronic device are received within a predefined time window.

### CROSS-REFERENCE TO RELATED APPLICATIONS

This application claims the benefit of priority from U.S. Provisional Patent Application No. 63/327,842, filed Apr. 6, 2022, and U.S. Provisional Patent Application No. 63/235,817, filed Aug. 23, 2021, which applications are incorporated herein by reference in their entirety.

### FIELD

The invention relates to location-based services in general.

### BACKGROUND

High-occupancy vehicle (HOV) lanes, high-occupancy toll (HOT) lanes, corporate car pools, and software applications that provide carpooling services promote ride-sharing by incentivizing vehicle passengers to travel together in the same vehicle, typically in an effort to reduce traffic congestion, CO₂ emissions, vehicle maintenance and operation expenses, and car fleet expenses. Such systems often require verifying the number of passengers in a vehicle during a trip at various points along the vehicle's route. Some existing solutions require the vehicle's driver, or the vehicle itself, as well as the vehicle's passengers to periodically report their current location to a monitor, such as where the driver or vehicle, as well as the passengers, are each equipped with an electronic device, such as a cellular telephone, that is capable of determining its current location based on communications with Global Positioning System (GPS) satellites, cell towers, or other devices. As such solutions require the electronic devices, which are typically battery-powered, to consume power in order to determine and report their current location, a solution that manages, and preferably reduces, such power consumption would be advantageous.

### SUMMARY

In one aspect of the invention a method is provided for determining the co-location of electronic devices, the method including receiving a communication from a primary electronic device, where the communication provides a current location of the primary electronic device, and where the primary electronic device is associated with a group, responsive to receiving the communication from the primary electronic device, sending to at least one secondary electronic device an instruction instructing the at least one secondary electronic device to provide a current location of the at least one secondary electronic device, where the at least one secondary electronic device is associated with the group, and where the instruction is sent to the at least one secondary electronic device within a predefined amount of time after the communication is received from the primary electronic device, receiving a communication from the at least one secondary electronic device, where the communication from the at least one secondary electronic device provides the current location of the at least one secondary electronic device, and determining that the electronic devices meet a predefined co-location condition by determining that the current location of the primary electronic device is within a predefined minimum distance from the current location of the at least one secondary electronic device, and determining that the communications from the primary electronic device and the at least one secondary electronic device are received within a predefined time window.

In another aspect of the invention the primary electronic device and the at least one secondary electronic device are configured to determine their current location.

In another aspect of the invention the primary electronic device and the at least one secondary electronic device are cellular telephones.

In another aspect of the invention the primary electronic device is installed in or assembled with a vehicle, and where the at least one secondary electronic device is a cellular telephone.

In another aspect of the invention the at least one secondary electronic device includes multiple electronic devices.

In another aspect of the invention the receiving, sending, and determining are performed multiple times in association with a moving vehicle transporting the electronic devices along a route.

In another aspect of the invention the primary electronic device is configured to determine its current location in accordance with a power-saving mode of an operating system with which the electronic device is configured.

In another aspect of the invention the electronic devices are associated with occupants of a vehicle traveling along a high-occupancy vehicle (HOV) lane or a high-occupancy toll (HOT) lane.

In another aspect of the invention the electronic devices are associated with occupants of a vehicle, where the occupants are traveling in association with a carpooling service.

In another aspect of the invention the receiving, sending, and determining are implemented in any of a) computer hardware, and b) computer software embodied in a non-transitory, computer-readable medium.

In another aspect of the invention a system is provided for determining the co-location of electronic devices, the system including a communications manager configured to receive a communication from a primary electronic device, where the communication provides a current location of the primary electronic device, and where the primary electronic device is associated with a group, responsive to receiving the communication from the primary electronic device, send to at least one secondary electronic device an instruction instructing the at least one secondary electronic device to provide a current location of the at least one secondary electronic device, where the at least one secondary electronic device is associated with the group, and where the instruction is sent to the at least one secondary electronic device within a predefined amount of time after the communication is received from the primary electronic device, and receive a communication from the at least one secondary electronic device, where the communication from the at least one secondary electronic device provides the current location of the at least one secondary electronic device, and a co-location manager configured to determine that the electronic devices meet a predefined co-location condition by determining that the current location of the primary electronic device is within a predefined minimum distance from the current location of the at least one secondary electronic device, and determining that the communications from the primary electronic device and the at least one secondary electronic device are received within a predefined time window.

In another aspect of the invention the primary electronic device and the at least one secondary electronic device are configured to determine their current location.

In another aspect of the invention the primary electronic device and the at least one secondary electronic device are cellular telephones.

In another aspect of the invention the primary electronic device is installed in or assembled with a vehicle, and where the at least one secondary electronic device is a cellular telephone.

In another aspect of the invention the at least one secondary electronic device includes multiple electronic devices.

In another aspect of the invention the communications are received multiple times in association with a moving vehicle transporting the electronic devices along a route.

In another aspect of the invention the primary electronic device is configured to determine its current location in accordance with a power-saving mode of an operating system with which the electronic device is configured.

In another aspect of the invention the electronic devices are associated with occupants of a vehicle traveling along a high-occupancy vehicle (HOV) lane or a high-occupancy toll (HOT) lane.

In another aspect of the invention the electronic devices are associated with occupants of a vehicle, where the occupants are traveling in association with a carpooling service.

In another aspect of the invention the communications manager and co-location manager are implemented in any of a) computer hardware, and b) computer software embodied in a non-transitory, computer-readable medium.

### BRIEF DESCRIPTION OF THE DRAWINGS

Aspects of the invention will be understood and appreciated more fully from the following detailed description taken in conjunction with the appended drawings in which:

FIG. 1 is a simplified conceptual illustration of a system for determining the co-location of electronic devices, constructed and operative in accordance with an embodiment of the invention;

FIG. 2 is a simplified flowchart illustration of an exemplary method of operation of the system of FIG. 1, operative in accordance with an embodiment of the invention;

FIG. 3 is a simplified block diagram illustration of an exemplary computing system in which one or more aspects of the invention may be implemented.

### DETAILED DESCRIPTION

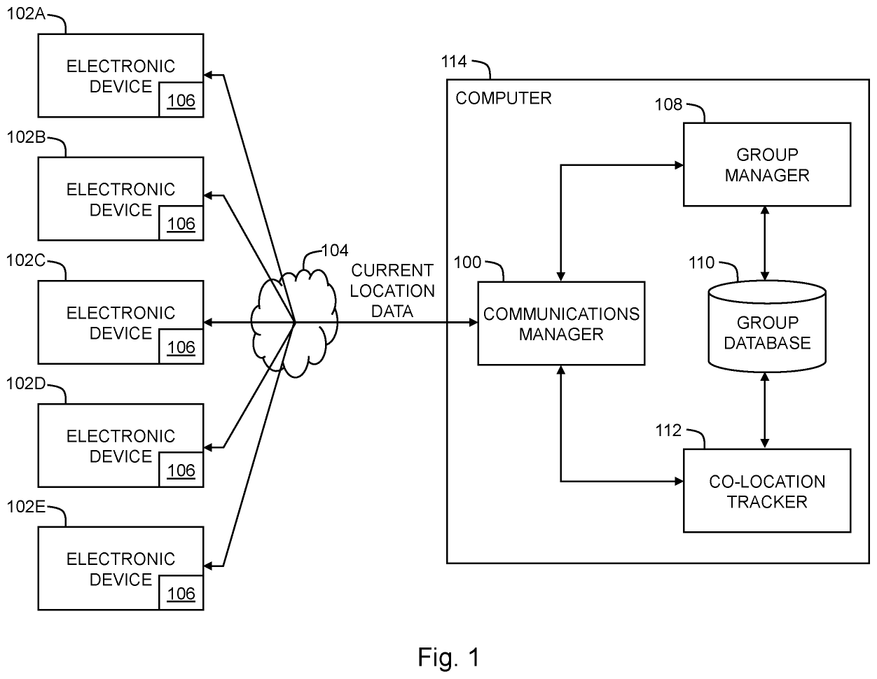

Reference is now made to FIG. 1, which is a simplified conceptual illustration of a system for determining the co-location of electronic devices, constructed and operative in accordance with an embodiment of the invention. In the system of FIG. 1, a communications manager 100 is configured, in accordance with conventional techniques, to communicate with electronic devices, such as, for example, electronic devices 102A, 102B, 102C, 102D, and 102E. In one example, electronic devices 102A, 102B, 102C, 102D, and 102E are all cellular telephones. In another example, electronic device 102A is assembled with or otherwise installed in a vehicle, such as an automobile, a bus, or a train car, and electronic devices 102B, 102C, 102D, and 102E are all cellular telephones. Communications manager 100 and electronic devices 102A, 102B, 102C, 102D, and 102E are configured, in accordance with conventional techniques, to communicate via a communications network 104, such as the Internet or a cellular telephone network.

Each of electronic devices 102A, 102B, 102C, 102D, and 102E is configured, in accordance with conventional techniques, to determine its current location, such as based on signals that each of electronic devices 102A, 102B, 102C, 102D, and 102E receives from Global Positioning System (GPS) satellites (not shown) or from cell phone towers (not shown). Each of electronic devices 102A, 102B, 102C, 102D, and 102E is also preferably configured with a software application 106 whose operation is described in greater detail hereinbelow.

A group manager 108 is configured, in accordance with conventional techniques, to maintain a group database 110 of one or more groups of electronic devices. In one example, an electronic device, such as electronic device 102A, sends a communication to communications manager 100 via communications network 104 indicating that electronic device 102A is to be designated as a primary device within a group, whereupon group manager 108 sends to electronic device 102A a unique group identifier identifying a group and associates electronic device 102A with the group. Thereafter, electronic devices 102B, 102C, 102D, and 102E receive the unique group identifier from electronic device 102A, such as by scanning a QR code displayed by electronic device 102A, where the QR code includes the unique group identifier. Electronic devices 102B, 102C, 102D, and 102E then send the unique group identifier to communications manager 100 via communications network 104 indicating that electronic devices 102B, 102C, 102D, and 102E are to be added to the same group as electronic device 102A. Group manager 108 maintains the group information in group database 110, indicating that electronic devices 102A, 102B, 102C, 102D, and 102E are the members of the group, and that electronic device 102A is designated as a primary device within the group.

Software application 106 is preferably configured to instruct the primary electronic device in a group to determine its current location and report its current location to communications manager 100 via communications network 104. In one embodiment, software application 106 instructs the primary electronic device to determine its current location in accordance with a power-saving mode of an operating system with which the electronic device is configured, such as Android™ or iOS™, where the power-saving mode determines when and how often the primary electronic device determines its current location. Whenever the primary electronic device determines its current location in accordance with its power-saving mode, software application 106 sends the current location of the primary electronic device to communications manager 100 via communications network 104.

Communications manager 100 is configured to receive a communication from a primary electronic device in a group, such as electronic device 102A, where the communication provides the current location of the primary electronic device. In response to receiving the communication from the primary electronic device, communications manager 100 identifies the group in database 110 in which the primary electronic device is a member, and sends to software application 106 of the other electronic devices that are members of the group—these other electronic devices now referred to as “secondary” electronic devices—an instruction instructing the secondary electronic devices to determine and provide their current locations to communications manager 100. Communications manager 100 sends the instruction to the secondary electronic devices within a predefined amount of time, such as 5000 milliseconds, after the communication is received from the primary electronic device. After each secondary electronic device determines its current location, its software application 106 sends its current location to communications manager 100 via communications network 104. A history of the current location data reported by the electronic devices in a group may be maintained, such as by group manager 108 in group database 110.

A co-location tracker 112 is configured to determine that the electronic devices in a group meet a predefined co-location condition by determining: a) that current locations of the electronic devices are within a predefined minimum distance from each other, such as 50 meters, from the current location of the each of the secondary electronic devices in the group, and b) that the communications from the primary electronic device and the secondary electronic devices in the group are received within a predefined time window, such as 10,000 milliseconds. A history of the co-location condition determined for a group may be maintained, such as by group manager 108 in group database 110.

The system of FIG. 1 is preferably configured to operate as described above to receive, over time, multiple sets of the current locations of the electronic devices in a group, where each set includes the current location of the primary electronic device in a group followed by the current location of the secondary electronic devices in the group.

Any of the elements shown in FIG. 1 are preferably implemented by one or more computers in computer hardware and/or in computer software embodied in a non-transitory, computer-readable medium in accordance with conventional techniques, such as where any of the elements shown in FIG. 1 are assembled with, hosted by, or are otherwise accessible to, a computer 114.

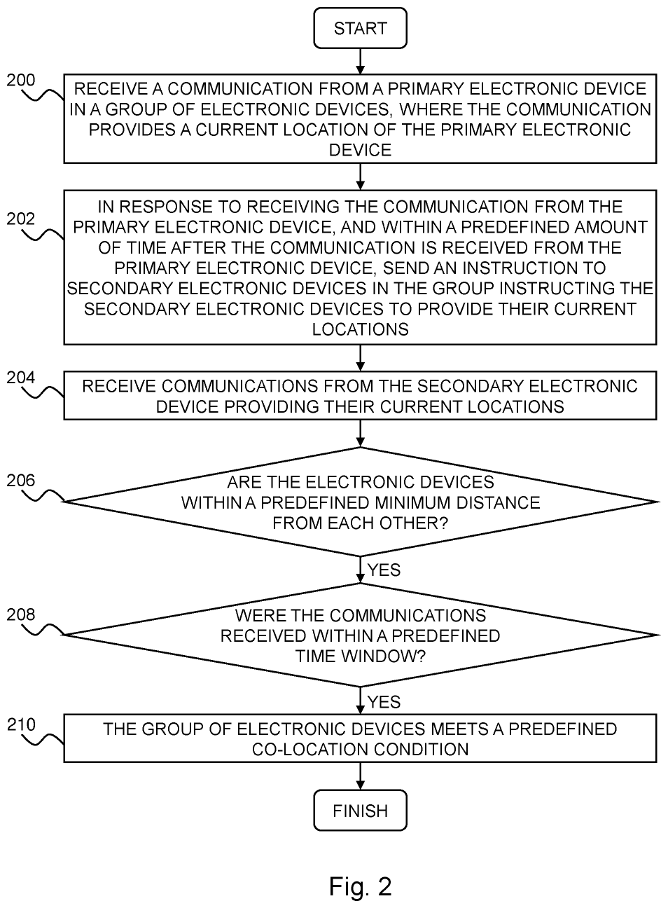

Reference is now made to FIG. 2, which is a simplified flowchart illustration of an exemplary method of operation of the system of FIG. 1, operative in accordance with an embodiment of the invention. In the method of FIG. 2, a communication is received from a primary electronic device in a group of electronic devices, where the communication provides a current location of the primary electronic device (step 200). In response to receiving the communication from the primary electronic device, and within a predefined amount of time after the communication is received from the primary electronic device, an instruction is sent to secondary electronic devices in the group instructing the secondary electronic devices to provide their current locations (step 202). After receiving communications from the secondary electronic device providing their current locations (step 204), if the current locations of the electronic devices are within a predefined minimum distance from each other (step 206), and if the communications from the primary electronic device and the secondary electronic device are received within a predefined time window (step 208), then the group of electronic devices are determined to meet a predefined co-location condition (step 210).

The system of FIG. 1 and method of FIG. 2 may be illustrated in the context of an exemplary operational scenario in which the steps of FIG. 2 are repeated multiple times for a group, such in association with a moving vehicle transporting the electronic devices of the group along a route, where the steps of FIG. 2 are performed at different points along the route. For example, the system of FIG. 1 and method of FIG. 2 may serve road operators that monitor high-occupancy vehicle (HOV) lanes or high-occupancy toll (HOT) lanes, as well as software applications that provide carpooling services, where the electronic devices are, for example, cellular telephones belonging to group including a driver of a vehicle and one or more passengers of the vehicle.

It will be appreciated that by managing a group of electronic devices, such as cellular telephones belonging to a vehicle's driver and passengers in a ride-sharing arrangement, such that secondary electronic devices in the group provide their current locations in response to a primary electronic device in the group providing its current location, where the primary electronic device preferably provides its current location in a power-saving mode, the invention provides an efficient solution for determining that the electronic devices meet a predefined co-location condition, and one that serves to reduce the power consumption of the electronic devices. It will be further appreciated that the invention may be implemented as part of a software application of carpooling service or as stand-alone application, such as may be used for the validation, measuring, and data analysis of other types of passenger-related applications, as well as for enforcement by authorities.

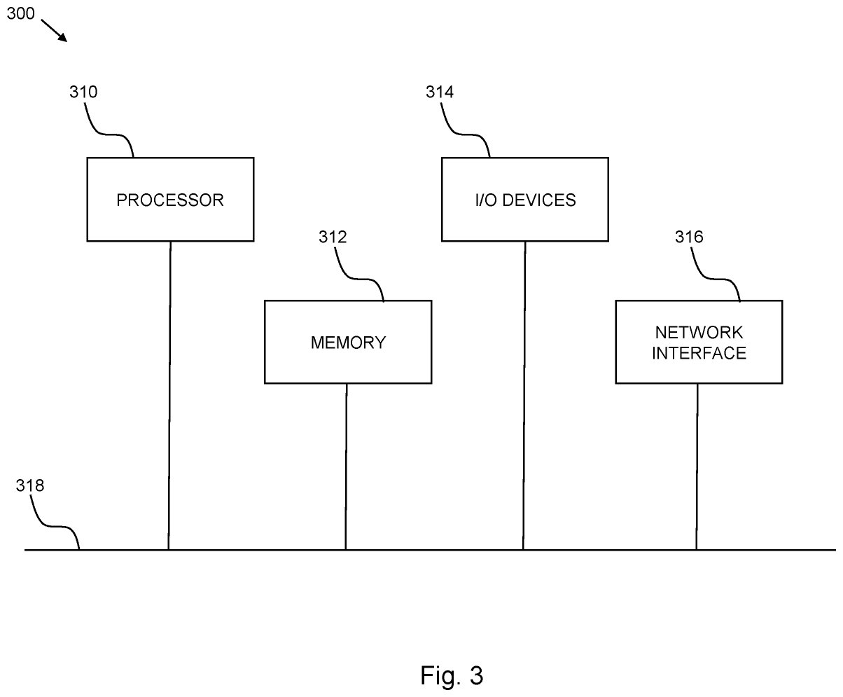

Reference is now made to FIG. 3, which is a simplified block diagram of an exemplary computing system 300 in which one or more aspects of the invention described herein may be implemented. As shown, computing system 300 includes a processor 310, a memory 312, I/O devices 314, and a network interface 316, coupled via a computer bus 318 or alternate connection arrangement.

It is to be appreciated that the term “processor” as used herein is intended to include any physical device (i.e., “hardware”) capable of executing computer instructions (i.e., “software”), such as, for example, a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for determining the co-location of electronic devices, the method comprising:
receiving a communication from a primary electronic device, wherein the communication provides a current location of the primary electronic device, and wherein the primary electronic device is associated with a group;
responsive to receiving the communication from the primary electronic device, sending to at least one secondary electronic device an instruction instructing the at least one secondary electronic device to provide a current location of the at least one secondary electronic device,
wherein the at least one secondary electronic device is associated with the group, and
wherein the instruction is sent to the at least one secondary electronic device within a predefined amount of time after the communication is received from the primary electronic device;
receiving a communication from the at least one secondary electronic device, wherein the communication from the at least one secondary electronic device provides the current location of the at least one secondary electronic device; and
determining that the electronic devices meet a predefined co-location condition by
determining that the current location of the primary electronic device is within a predefined minimum distance from the current location of the at least one secondary electronic device, and
determining that the communications from the primary electronic device and the at least one secondary electronic device are received within a predefined time window.

2. The method according to claim 1 wherein the primary electronic device and the at least one secondary electronic device are configured to determine their current location.

3. The method according to claim 1 wherein the primary electronic device and the at least one secondary electronic device are cellular telephones.

4. The method according to claim 1 wherein the primary electronic device is installed in or assembled with a vehicle, and wherein the at least one secondary electronic device is a cellular telephone.

5. The method according to claim 1 wherein the at least one secondary electronic device includes multiple electronic devices.

6. The method according to claim 1 wherein the receiving, sending, and determining are performed multiple times in association with a moving vehicle transporting the electronic devices along a route.

7. The method according to claim 1 wherein the primary electronic device is configured to determine its current location in accordance with a power-saving mode of an operating system with which the electronic device is configured.

8. The method according to claim 1 wherein the electronic devices are associated with any of a vehicle and occupants of the vehicle traveling along a high-occupancy vehicle (HOV) lane or a high-occupancy toll (HOT) lane.

9. The method according to claim 1 wherein the electronic devices are associated with any of a vehicle and occupants of the vehicle, wherein the occupants are traveling in association with a carpooling service.

10. The method according to claim 1 wherein the receiving, sending, and determining are implemented in any of
a) computer hardware, and
b) computer software embodied in a non-transitory, computer-readable medium.

11. A system for determining the co-location of electronic devices, the system comprising:
a communications manager configured to
receive a communication from a primary electronic device, wherein the communication provides a current location of the primary electronic device, and wherein the primary electronic device is associated with a group,
responsive to receiving the communication from the primary electronic device, send to at least one secondary electronic device an instruction instructing the at least one secondary electronic device to provide a current location of the at least one secondary electronic device,
wherein the at least one secondary electronic device is associated with the group, and
wherein the instruction is sent to the at least one secondary electronic device within a predefined amount of time after the communication is received from the primary electronic device, and
receive a communication from the at least one secondary electronic device, wherein the communication from the at least one secondary electronic device provides the current location of the at least one secondary electronic device; and
a co-location manager configured to determine that the electronic devices meet a predefined co-location condition by
determining that the current location of the primary electronic device is within a predefined minimum distance from the current location of the at least one secondary electronic device, and
determining that the communications from the primary electronic device and the at least one secondary electronic device are received within a predefined time window.

12. The system according to claim 11 wherein the primary electronic device and the at least one secondary electronic device are configured to determine their current location.

13. The system according to claim 11 wherein the primary electronic device and the at least one secondary electronic device are cellular telephones.

14. The system according to claim 11 wherein the primary electronic device is installed in or assembled with a vehicle, and wherein the at least one secondary electronic device is a cellular telephone.

15. The system according to claim 11 wherein the at least one secondary electronic device includes multiple electronic devices.

16. The system according to claim 11 wherein the communications are received multiple times in association with a moving vehicle transporting the electronic devices along a route.

17. The system according to claim 11 wherein the primary electronic device is configured to determine its current location in accordance with a power-saving mode of an operating system with which the electronic device is configured.

18. The system according to claim 1 wherein the electronic devices are associated with any of a vehicle and occupants of the vehicle traveling along a high-occupancy vehicle (HOV) lane or a high-occupancy toll (HOT) lane.

19. The system according to claim 1 wherein the electronic devices are associated with any of a vehicle and occupants of the vehicle, wherein the occupants are traveling in association with a carpooling service.

20. The system according to claim 11 wherein the communications manager and co-location manager are implemented in any of
a) computer hardware, and
b) computer software embodied in a non-transitory, computer-readable medium.
